(19) United States
(12) Patent Application Publication
(10) Pub. No.: US 2023/0065204 A1
(43) Pub. Date: Mar. 2, 2023

(54) DETECTING LOAD SHIFT OF CARGO ON A VEHICLE AND/OR A TRAILER

(71) Applicants: Ningbo Geely Automobile Research & Development Co. ,Ltd., Ningbo (CN); Zhejiang Geely Holding Group Co., Ltd., Zhejiang (CN)

(72) Inventors: Jonathan JOHANSSON, Göteborg (SE); Magnus NILSSON, Floda (SE)

(21) Appl. No.: 17/985,249

(22) Filed: Nov. 11, 2022

Related U.S. Application Data
(63) Continuation of application No. PCT/CN2021/097171, filed on May 31, 2021.

(30) Foreign Application Priority Data
Jun. 12, 2020 (EP) 20179753.7

(51) Int. Cl. B60Q 9/00

(52) U.S. Cl. CPC B60Q 9/00

(57) ABSTRACT

A method for detecting load shift of cargo on a vehicle and/or a trailer during transport, wherein cargo is restrained to the vehicle and/or the trailer by one or more restraining components. The method includes obtaining sensor data of the one or more restraining components via one or more sensors, wherein the one or more sensors are arranged on the vehicle and/or the trailer, receiving the obtained sensor data in a controlling circuitry, comparing the received sensor data over time in the controlling circuitry in order to establish differences in the received sensor data, and determining in the controlling circuitry whether any established differences in the received sensor data meet or exceed a set threshold for the one or more restraining components, wherein the set threshold is indicative of movement in the one or more restraining components capable of allowing load shift of the cargo.

### RELATED APPLICATION DATA

This application is a continuation of International Patent Application No. PCT/CN2021/097171, filed May 31, 2021, which claims the benefit of European Patent Application No. 20179753.7, filed Jun. 12, 2020, the disclosures of which are incorporated herein by reference in their entireties.

### TECHNICAL FIELD

The present disclosure relates generally to the field of load shift of cargo. More particularly, it relates to detecting load shift of cargo on a vehicle and/or a trailer during transport.

### BACKGROUND

A user that has strapped down cargo (i.e., load) on a vehicle, e.g. on the roof of the vehicle, and/or a trailer, wherein the strapped down cargo is not visible to the user during transport, may cause the user to become worried that the strapped down cargo is about to slip its bonds and escape and pose a danger to other vehicles in traffic.

A first drawback of the strapped down cargo is that the user may become worried about the stability of the cargo during transport.

A second drawback of the strapped down cargo is that instability of the cargo during transport may pose a danger to other vehicles in traffic.

Therefore, there is a need for approaches for detecting load shift of cargo on a vehicle and/or a trailer during transport.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an apparatus is referred to herein, it is to be understood as a physical product. The physical product may comprise one or more parts, such as controlling circuitry in the form of one or more controllers, one or more processors, or the like.

It is an object of some embodiments to solve or mitigate, alleviate, or eliminate at least some of the above or other drawbacks.

According to a first aspect, this is achieved by a method for detecting load shift of cargo on a vehicle and/or a trailer during transport, wherein cargo is restrained to the vehicle and/or the trailer by one or more restraining components.

The method comprises obtaining sensor data of the one or more restraining components via one or more sensors, wherein the one or more sensors are arranged on the vehicle and/or the trailer.

The method further comprises receiving the obtained sensor data in a controlling circuitry, comparing the received sensor data over time in the controlling circuitry in order to establish differences in the received sensor data, and determining in the controlling circuitry whether any established differences in the received sensor data meet or exceed a set threshold for the one or more restraining components, wherein the set threshold is indicative of movement in the one or more restraining components capable of allowing load shift of the cargo.

An advantage of some embodiments is that approaches for detecting load shift of cargo on a vehicle and/or a trailer during transport are provided.

Yet an advantage of some embodiments is that a user is less worried about the stability of the cargo during transport as one or more restraining components are monitored, and instability of the cargo in terms of load shift is detected and notified to the user.

Yet an advantage of some embodiments is that safety for other vehicles in traffic is increased as one or more restraining components is monitored during transport, and instability of the cargo in terms of load shift is detected and notified to the user.

Yet an advantage of some embodiments is that insurance liability is reduced for vehicles and/or trailers with cargo as one or more restraining components are monitored during transport and thereby reducing the risk of the cargo slipping its bonds and escaping.

Yet an advantage of some embodiments is that an early detection of instability of the cargo in terms of load shift during transport is enabled as the monitoring is focused on the one or more restraining components.

Yet an advantage of some embodiments is that the focused monitoring on the one or more restraining components reduces the processing needed, compared to prior art approaches, to establish differences in the received sensor data.

Yet an advantage of some embodiments is that load shift of cargo is identified before the cargo slips its bonds and escapes.

Yet an advantage of some embodiments is that a risk is reduced of a vehicle being caused to swerve and crash due to load shifted cargo on a connected trailer.

In some embodiments, the one or more sensors are arranged on the vehicle and/or the trailer to have a non-obstructed view of the one or more restraining components.

An advantage of some embodiments is that any movement in the in the restraining components is observed.

In some embodiments, the one or more sensors are arranged on the vehicle and/or the trailer to be operably connected to the one or more restraining components and configured to measure vibrations in the one or more restraining components.

An advantage of some embodiments is that any vibrations or shock caused by movement in the restraining components is detected.

In some embodiments, the one or more restraining components comprise one or more fastening components connected and/or fixated to one or more load fixation components.

An advantage of some embodiments is that since load shift of cargo typically starts with movements in the fastening components and/or in the load fixation components an early detection of movement in these restraining components enables an early detection of load shift of cargo.

In some embodiments, the one or more load fixation components comprise one or more of: rails, tie-downs, chassis, and towbar.

An advantage of some embodiments is that different types of load fixation components may be monitored in order to detect movement in the load fixation components.

In some embodiments, the one or more fastening components comprise one or more of: ropes, nets, chains, ratchet straps, tape, wire cable, rubber cord, and straps.

An advantage of some embodiments is that different types of fastening components may be monitored in order to detect movement in the fastening components.

In some embodiments, the one or more sensors comprise image sensors and/or camera sensors and/or piezoelectric sensors.

An advantage of some embodiments is that the image and/or camera sensors and/or piezoelectric sensors provide data which may be processed and analysed in order establish differences in the received sensor data over time.

In some embodiments, the sensor data comprises image data and/or video data and/or vibration data.

An advantage of some embodiments is that the image and/or video data and/or vibration data is suitable for being processed and analysed in order establish differences in the received sensor data over time.

In some embodiments, the controlling circuitry further comprises a buffer for temporarily storing the received data before comparison.

An advantage of some embodiments is that received sensor data may be stored temporarily and processed in due time without overloading the controlling circuitry.

In some embodiments, the controlling circuitry and/or the buffer is comprised completely or partially in the vehicle and/or remotely in a cloud environment.

An advantage of some embodiments is that processing capacity and/or storing capacity may be scalable by processing and/or storing completely or partially in the vehicle respectively in the cloud environment.

In some embodiments, cargo is restrained to the roof of the vehicle and/or on the trailer.

An advantage of some embodiments is that one or more restraining components may be utilized to restrain the cargo on the roof of the vehicle and/or on the trailer.

In some embodiments, the method further comprises notifying a user of the vehicle via a display and/or a sound in the vehicle of movement in the one or more restraining components capable of allowing load shift of the cargo.

An advantage of some embodiments is that a user may be notified during transport and may take actions based on the notification and thereby increasing security for other vehicles in traffic.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is a system for detecting load shift of cargo on a vehicle and/or a trailer during transport, wherein cargo is restrained to the vehicle and/or the trailer by one or more restraining components.

The system comprises controlling circuitry being configured to cause obtainment of sensor data of the one or more restraining components via one or more sensors, wherein the one or more sensors are arranged on the vehicle and/or the trailer.

The controlling circuitry being further configured to cause reception of the obtained sensor data, comparison of the received sensor data over time in order to establish differences in the received sensor data, and determination of whether any established differences in the received sensor data meet or exceed a set threshold for the one or more restraining components, wherein the set threshold is indicative of movement in the one or more restraining components capable of allowing load shift of the cargo.

An advantage of some embodiments is that approaches for detecting load shift of cargo on a vehicle and/or a trailer during transport are provided.

Yet an advantage of some embodiments is that a user is less worried about the stability of the cargo during transport as one or more restraining components are monitored, and instability of the cargo in terms of load shift is detected and notified to the user.

Yet an advantage of some embodiments is that safety for other vehicles in traffic is increased as one or more restraining components is monitored during transport, and instability of the cargo in terms of load shift is detected and notified to the user.

Yet an advantage of some embodiments is that insurance liability is reduced for vehicles and/or trailers with cargo as one or more restraining components are monitored during transport and thereby reducing the risk of the cargo slipping its bonds and escaping.

Yet an advantage of some embodiments is that an early detection of instability of the cargo in terms of load shift during transport is enabled as the monitoring is focused on the one or more restraining components.

Yet an advantage of some embodiments is that the focused monitoring on the one or more restraining components reduces the processing needed, compared to prior art approaches, to establish differences in the received sensor data.

Yet an advantage of some embodiments is that load shift of cargo is identified before the cargo slips its bonds and escapes.

Yet an advantage of some embodiments is that a risk is reduced of a vehicle being caused to swerve and crash due to load shifted cargo on a connected trailer.

In some embodiments, the one or more sensors are arranged on the vehicle and/or the trailer to have a non-obstructed view of the one or more restraining components.

An advantage of some embodiments is that any movement in the in the restraining components is observed.

In some embodiments, the one or more sensors are arranged on the vehicle and/or the trailer to be operably connected to the one or more restraining components and configured to measure vibrations in the one or more restraining components.

An advantage of some embodiments is that any vibrations or shock caused by movement in the restraining components is detected.

In some embodiments, the one or more restraining components comprise one or more fastening components connected and/or fixated to one or more load fixation components.

An advantage of some embodiments is that since load shift of cargo typically starts with movements in the fastening components and/or in the load fixation components an early detection of movement in these restraining components enables an early detection of load shift of cargo.

In some embodiments, the controlling circuitry further comprises a buffer for temporarily storing the received data before comparison.

An advantage of some embodiments is that received sensor data may be stored temporarily and processed in due time without overloading the controlling circuitry.

In some embodiments, the controlling circuitry and/or the buffer is comprised completely or partially in the vehicle and/or remotely in a cloud environment.

An advantage of some embodiments is that processing capacity and/or storing capacity may be scalable by processing and/or storing completely or partially in the vehicle respectively in the cloud environment.

In some embodiments, the system is further configured to cause notification to a user of the vehicle via a display and/or a sound in the vehicle of movement in the one or more restraining components capable of allowing load shift of the cargo.

An advantage of some embodiments is that a user may be notified during transport and may take actions based on the notification and thereby increasing security for other vehicles in traffic.

In some embodiments, the system is continuously active during transport for detecting load shift of cargo on the vehicle and/or the trailer or only active when the user of the vehicle activates it during transport.

An advantage of some embodiments is that when the system is continuously active during transport the user is not burdened with remembering to activate the system.

An advantage of some embodiments is that when the system is only active when the user activates it is that the user chooses when the function is to be activated.

A fourth aspect is a vehicle comprising the system according to the third aspect.

Any of the above aspects may additionally have features identical with or corresponding to any of the various features as explained above for any of the other aspects.

It should be noted that, even if embodiments are described herein in the context of detecting load shift of cargo, some embodiments may be equally applicable and/or beneficial also in other contexts.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1A is a flowchart illustrating example method steps according to some embodiments;

FIG. 1B is a flowchart illustrating example method steps according to some embodiments;

FIG. 2A is a schematic drawing illustrating an example system according to some embodiments;

FIG. 2B is a schematic drawing illustrating an example system according to some embodiments;

FIG. 2C is a schematic drawing illustrating an example system according to some embodiments;

FIG. 3 is a schematic drawing illustrating an example system according to some embodiments;

FIG. 4 is a schematic block diagram illustrating an example apparatus according to some embodiments; and

FIG. 5 is a schematic drawing illustrating an example computer readable medium according to some embodiments.

### DETAILED DESCRIPTION

As already mentioned above, it should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

As mentioned above, a first drawback of the strapped down cargo is that the user may become worried about the stability of the cargo during transport.

Further, as mentioned above, a second drawback of the strapped down cargo is that instability of the cargo during transport may pose a danger to other vehicles in traffic.

In the following, embodiments will be presented where approaches for detecting load shift of cargo on a vehicle and/or a trailer during transport are described.

Detection, as described herein, typically comprises of detection of movement or vibration caused by movement in one or more restraining components arranged to restrict cargo on a vehicle and/or a trailer.

Cargo, as described herein, typically comprises load restrained by one or more restraining component on a vehicle and/or a trailer.

A vehicle, as described herein, typically comprises a vehicle capable of being loaded with cargo and transporting the loaded cargo.

A trailer, as described herein, typically comprises a vehicle configured to be loaded with cargo and which is not capable of moving on its own but is typically connectable to a vehicle which may pull the trailer.

It should be noted that, even if embodiments are described herein in the context of detecting load shift of cargo on a vehicle and/or a trailer during transport, some embodiments may be equally applicable and/or beneficial also in other contexts wherein load shift of cargo is detected.

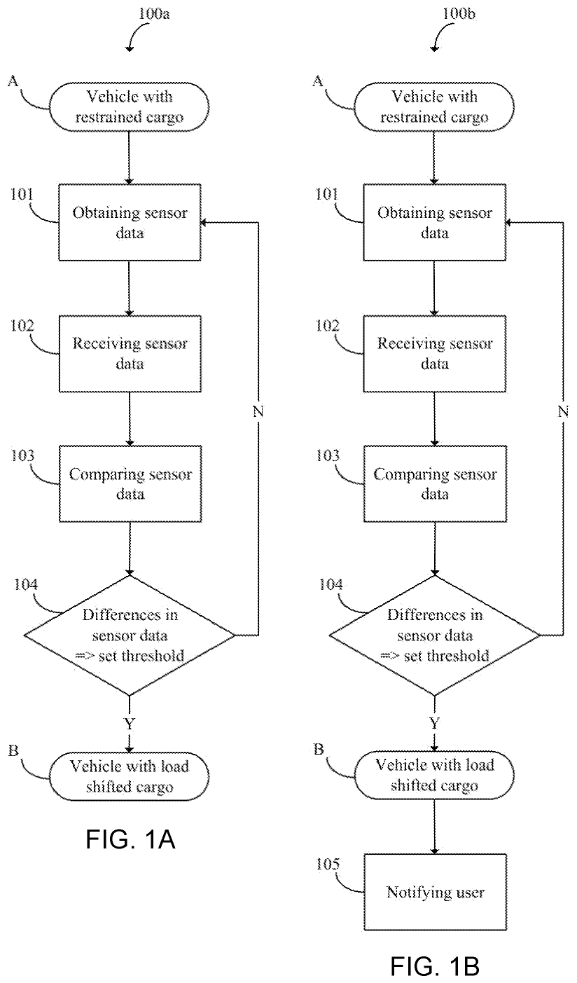

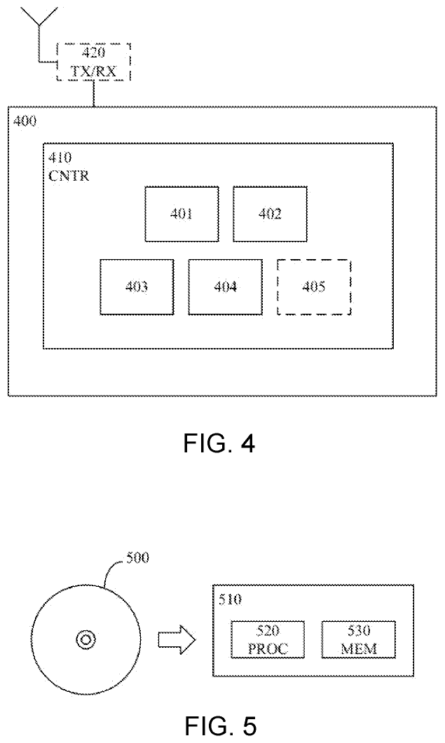

FIG. 1A is a flowchart illustrating method steps of an example method 100a according to some embodiments. The method 100a is for detecting load shift of cargo on a vehicle and/or a trailer during transport, wherein cargo is restrained to the vehicle and/or the trailer by one or more restraining components. Thus, the method 100a may, for example, be performed by the apparatus 400 and/or the controller 410 of FIG. 4; all of which will be described later herein.

The method 100a comprises the following steps.

The method 100a starts with a state A of a vehicle-vehicle with restrained cargo.

In step 101, sensor data of the one or more restraining components is obtained via one or more sensors, wherein the one or more sensors are arranged on the vehicle and/or the trailer.

In some embodiments, the one or more sensors are arranged on the vehicle and/or the trailer to have a non-obstructed view of the one or more restraining components. Alternatively or additionally, the one or more sensors may be arranged on the one or more restraining components to have a non-obstructed view of other restraining components.

Alternatively or additionally, the one or more sensors may be arranged on the cargo to have a non-obstructed view of the one or more restraining components.

In some embodiments, the one or more sensors comprise image sensors and/or camera sensors.

In some embodiments, the one or more sensors are arranged on the vehicle and/or the trailer to be operably connected to the one or more restraining components and configured to measure vibrations in the one or more restraining components.

Alternatively or additionally, the one or more sensors may be operably connected to rails and configured to measure vibrations and/or shock in the rails caused by movement in the one or more restraining components.

For example, the one or more sensors may be embedded in the rails.

In some embodiments, the one or more sensors comprise vibration sensors.

For example, the one or more vibration sensors may comprise piezoelectric sensors.

Alternatively or additionally, the one or more sensors arranged on the vehicle may comprise image sensors and/or camera sensors as well as vibration sensors.

In some embodiments, the one or more restraining components comprise one or more fastening components connected and/or fixated to one or more load fixation components.

In some embodiments, the one or more load fixation components comprise one or more of: rails, tie-downs, chassis, and towbar.

In some embodiments, the one or more fastening components comprise one or more of: ropes, nets, chains, ratchet straps, tape, wire cable, rubber cord, and straps.

In some embodiments, cargo is restrained to the roof of the vehicle and/or on the trailer.

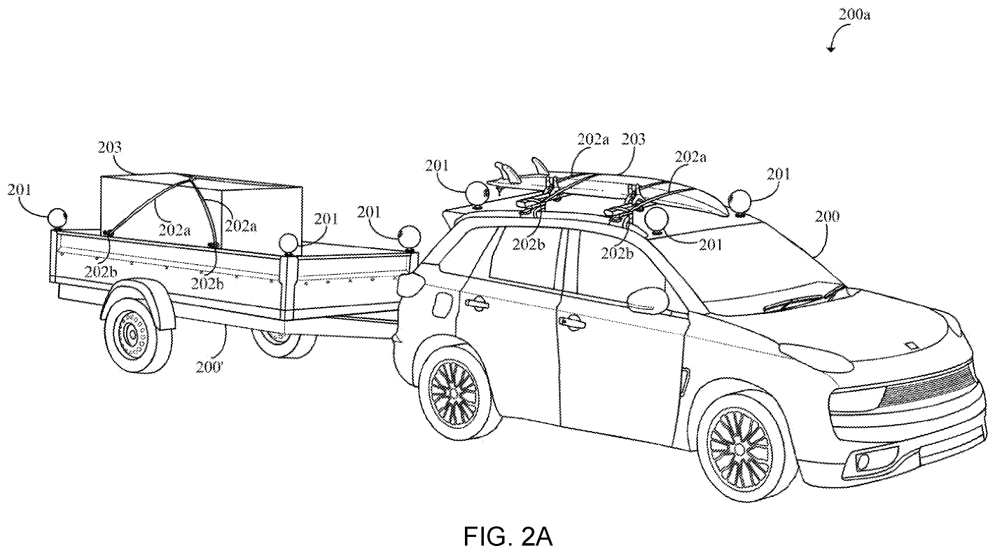

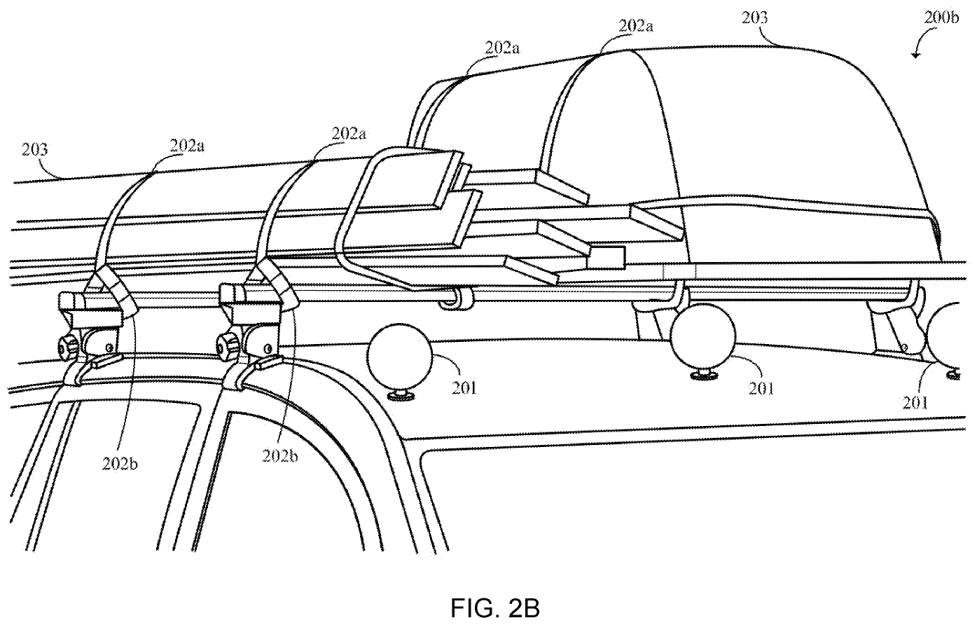

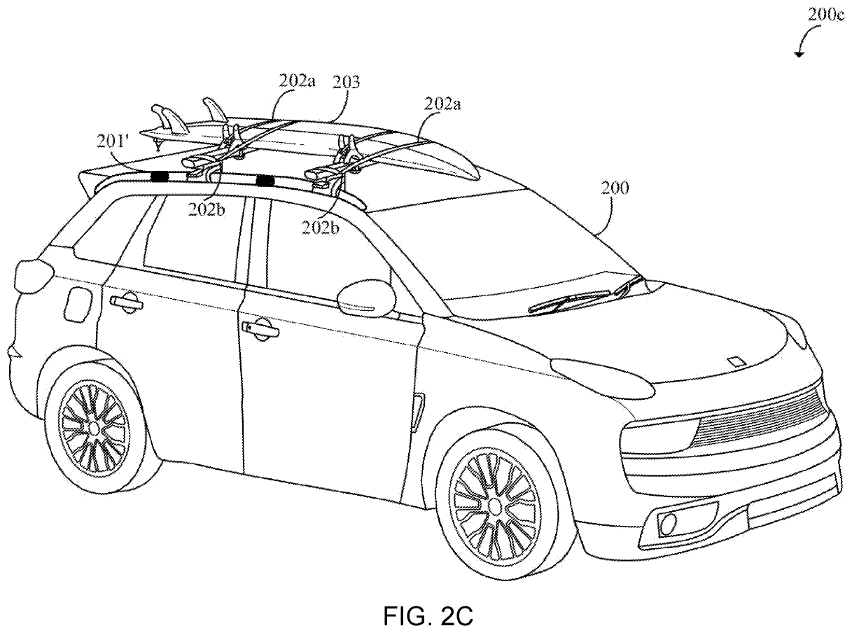

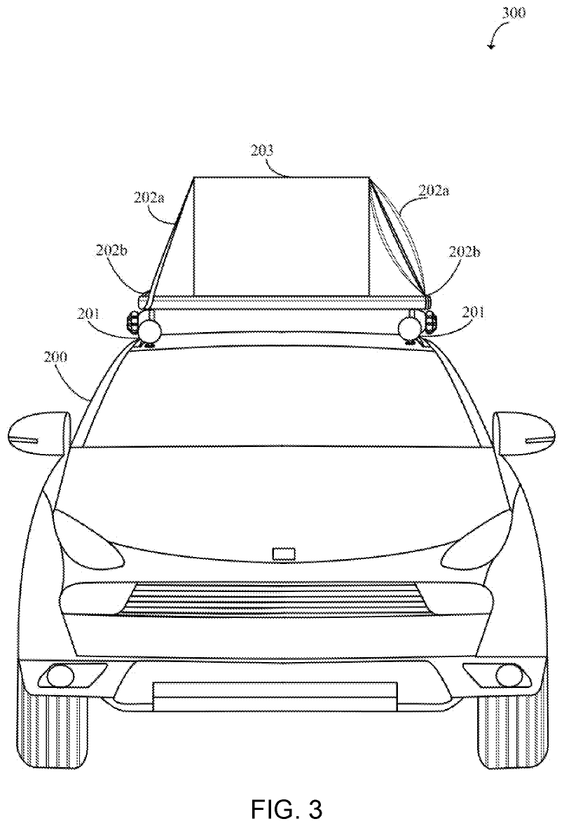

For example, straps may be connected and fixated to rails of a vehicle for restraining cargo to the roof of a vehicle. The one or more restraining components to be monitored, i.e., to obtain image/camera/vibration sensor data from, comprise the points of which the straps restraining the load are fixated to the rails (i.e., load fixation components) and/or one or more sections of the actual straps (reference to FIGS. 2A-2C and FIG. 3).

In step 102, the obtained sensor data is received in a controlling circuitry.

In some embodiments, the controlling circuitry further comprises a buffer for temporarily storing the received data before comparison.

In some embodiments, the controlling circuitry and/or the buffer is comprised completely or partially in the vehicle and/or remotely in a cloud environment.

Alternatively or additionally, the controlling circuitry may be operably connected to the vehicle and may be comprised partially or completely in a cloud environment.

In some embodiments, the sensor data comprises image data and/or video data and/or vibration data.

In step 103, the received sensor data is compared over time in the controlling circuitry in order to establish differences in the received sensor data.

In some embodiments, the comparing of the received sensor data comprises a frame-by-frame analysis for establishing differences per frame.

In some embodiments, the comparing of the received sensor data comprises an analysis of frequencies.

For example, the analysis may comprise determining a time between a first and a second frame and an (approximate) position of the monitored restraining component at the first respectively at the second frame in order to establish if there are any differences in position, e.g., to determine if the restraining component is in the same place, wherein low frequencies are indicative of a low tension in the restraining component and a possible problem in terms of load shift.

In some embodiments, the comparing of the received sensor data comprises analysis of the vibration data, i.e., vibration levels over time, to determine if the restraining component is loose, wherein high vibration levels are indicative of a low tension in the restraining component and a possible problem in terms of load shift.

In step 104, it is determined in the controlling circuitry whether any established differences in the received sensor data meet or exceed a set threshold for the one or more restraining components, wherein the set threshold is indicative of movement in the one or more restraining components capable of allowing load shift of the cargo.

Alternatively or additionally, the set threshold may differ for different restraining components.

For example, the load fixation component may have a set threshold which is lower than a set threshold for the fastening components as the load fixation component provides fixation to the fastening components and should have a lower tolerance, i.e., threshold, for movement than for e.g. a strap connected and fixated to the load fixation component.

Alternatively or additionally, the set threshold may differ during transport.

For example, during transport, when the vehicle is moving at 30 km/h, the threshold may be set to exceed movement caused by air resistance and vibrations normally generated at 30 km/h in the one or more restraining components. Hence, the set threshold should have a lower tolerance for movement in lower speeds as there is typically less movements generated in lower speeds by air resistance and vibrations.

For example, during transport, when the vehicle is moving at 110 km/h, the threshold may be set to exceed movement caused by air resistance and vibrations normally generated at 110 km/h in the one or more restraining components. Hence, the set threshold should have a higher tolerance for movement in higher speeds as there is typically more movements generated in higher speeds by air resistance and vibrations.

The method 100a ends with a state B of the vehicle-vehicle with load shifted cargo—when it is determined that there is movement in the one or more restraining components capable of allowing load shift of the cargo.

FIG. 1B is a flowchart illustrating method steps of an example method 100b according to some embodiments. The method 100b is for detecting load shift of cargo on a vehicle and/or a trailer during transport, wherein cargo is restrained to the vehicle and/or the trailer by one or more restraining components. Thus, the method 100b may, for example, be performed by the apparatus 400 and/or the controller 410 of FIG. 4; all of which will be described later herein.

The method 100b comprises the following steps.

The method 100b starts with a state A of a vehicle-vehicle with restrained cargo.

In step 101, sensor data of the one or more restraining components is obtained via one or more sensors, wherein the one or more sensors are arranged on the vehicle and/or the trailer to have a non-obstructed view of one or more restraining components (corresponding to step 101 of FIG. 1A).

In step 102, the obtained sensor data is received in a controlling circuitry (corresponding to step 102 of FIG. 1A).

In step 103, the received sensor data is compared over time in the controlling circuitry in order to establish differences in the received sensor data (corresponding to step 103 of FIG. 1A).

In step 104, it is determined in the controlling circuitry whether any established differences in the received sensor data meet or exceed a set threshold for the one or more restraining components, wherein the set threshold is indicative of movement in the one or more restraining components capable of allowing load shift of the cargo (corresponding to step 104 of FIG. 1A).

The method 100b includes a state B of the vehicle-vehicle with load shifted cargo —when it is determined that there is movement in the one or more restraining components capable of allowing load shift of the cargo.

In optional step 105, in some embodiments, a user of the vehicle is notified via a display and/or a sound in the vehicle of movement in the one or more restraining components capable of allowing load shift of the cargo.

Alternatively or additionally, the user may stop the vehicle in response to the notification and further restrict the cargo on the vehicle and/or the trailer.

Alternatively or additionally, the user may ignore the notification and manually set a higher threshold for movement in the one or more restraining components.

For example, the threshold for the load fixation components(s) may be kept but the threshold of the fastening components may be set to higher in case air resistance causes more movement than normally in the fastening components.

FIG. 2A is a schematic drawing illustrating components of an example system 200a according to some embodiments. The system 200a is for detecting load shift of cargo on a vehicle and/or a trailer during transport, wherein cargo is restrained to the vehicle and/or the trailer by one or more restraining components. Thus, the system 200a may, for example, comprise the apparatus 400 and/or the controller 410 of FIG. 4; all of which will be described later herein, as well as be configured to perform the method steps of FIG. 1A and/or FIG. 1B.

The system 200a comprises the following components.

Cargo 203 is loaded and restricted on the roof of a vehicle 200 and on a trailer 200′ connected to the vehicle 200.

The cargo 203 is restricted on the vehicle 200 and on the trailer 200′ by one or more restraining components 202a and 202b.

The restraining components comprise fastening components 202a connected and/or fixated to one or more load fixation components 202b.

In the system 200a, straps, i.e., fastening components 202a, are connected and fixated to rails, i.e., load fixation components 202b, on the roof of the vehicle 200 for restraining the cargo 203 (e.g., a surfboard). The one or more restraining components, i.e., the fastening components 202a and/or load fixation components 202b, to be monitored, i.e., to obtain sensor data from, comprise the points of which the straps restraining the load are fixated to the rails (i.e., the load fixation components) and/or one or more sections of the actual straps (i.e., the fastening components).

In the system 200a, a trailer 200′ in a similar manner as the vehicle 200, carries restrained cargo (e.g., a box) 203. The cargo 203 is restrained by straps, i.e., fastening components 202a, which are connected and fixated to edges of the trailer 200′, i.e., load fixation components 202b, for restraining the cargo 203. The one or more restraining components, i.e., the fastening components 202a and/or load fixation components 202b, to be monitored, i.e., to obtain sensor data from, comprise the points of which the straps 202a restraining the load 203 are fixated to the rails 202b (i.e., load fixation components) and/or one or more sections of the actual straps (i.e., the fastening components).

The one or more restraining components 202a and 202b are monitored by one or more sensors 201 arranged on the vehicle 200 and the trailer 200′ to have a non-obstructed view (i.e., a clear view) of the one or more restraining components 202a and 202b.

For example, the one or more sensors 201 may comprise a rear camera, e.g., a rear camera for parking assistance, on the vehicle 200 which has a clear view of the trailer 200′ and the one or more restraining components 202a and 202b.

Alternatively or additionally, the one or more sensors 201 may be arranged on the one or more restraining components 202a and 202b to have a non-obstructed view of other restraining components 202a and 202b.

Alternatively or additionally, the one or more sensors 201 may be arranged on the cargo 203 to have a non-obstructed view of the restraining components 202a and 202b.

In the system 200a, the one or more sensors 201 comprise image sensors and/or camera sensors configured to obtain sensor data, e.g., image data and/or video data, of the one or more restraining components 202a and 202b during transport.

FIG. 2B is a schematic drawing illustrating components of an example system 200b according to some embodiments. The system 200b is for detecting load shift of cargo on a vehicle and/or a trailer during transport, wherein cargo is restrained to the vehicle and/or the trailer by one or more restraining components. Thus, the system 200b may, for example, comprise the apparatus 400 and/or the controller 410 of FIG. 4; all of which will be described later herein, as well as be configured to perform the method steps of FIG. 1A and/or FIG. 1B.

The system 200b comprises the following components.

Cargo 203 is loaded and restricted on the roof of a vehicle.

The cargo 203 (e.g., a bathtub and wooden planks) is restricted on the vehicle by one or more restraining components 202a and 202b.

The restraining components comprise fastening components 202a connected and/or fixated to one or more load fixation components 202b.

In the system 200b, straps, i.e., fastening components 202a, are connected and fixated to rails, i.e., load fixation components 202b, on the roof of the vehicle 200 for restraining the cargo 203. The one or more restraining components, i.e., the fastening components 202a and/or load fixation components 202b, to be monitored, i.e., to obtain sensor data from, comprise the points of which the straps restraining the load are fixated to the rails (i.e., load fixation components) and/or one or more sections of the actual straps (i.e., fastening components).

The one or more restraining components 202a and 202b are monitored by one or more sensors 201 arranged on the vehicle (i.e., on the roof of the vehicle) to have a non-obstructed view (i.e., a clear view) of the one or more restraining components 202a and 202b.

Alternatively or additionally, the one or more sensors 201 may be arranged on the one or more restraining components 202a and 202b to have a non-obstructed view of other restraining components 202a and 202b.

Alternatively or additionally, the one or more sensors 201 may be arranged on the cargo 203 to have a non-obstructed view of the restraining components 202a and 202b.

In the system 200b, the one or more sensors 201 comprise image sensors and/or camera sensors configured to obtain sensor data, e.g., image data and/or video data, of the one or more restraining components 202a and 202b during transport.

FIG. 2C is a schematic drawing illustrating components of an example system 200c according to some embodiments. The system 200c is for detecting load shift of cargo on a vehicle and/or a trailer during transport, wherein cargo is restrained to the vehicle and/or the trailer by one or more restraining components. Thus, the system 200c may, for example, comprise the apparatus 400 and/or the controller 410 of FIG. 4; all of which will be described later herein, as well as be configured to perform the method steps of FIG. 1A and/or FIG. 1B.

The system 200c comprises the following components.

Cargo 203 is loaded and restricted on the roof of a vehicle 200.

The cargo 203 is restricted on the vehicle 200 by one or more restraining components 202a and 202b.

The restraining components comprise fastening components 202a connected and/or fixated to one or more load fixation components 202b.

In the system 200c, straps, i.e., fastening components 202a, are connected and fixated to rails, i.e., load fixation components 202b, on the roof of the vehicle 200 for restraining the cargo 203 (e.g., a surfboard). The one or more restraining components, i.e., the fastening components 202a and/or load fixation components 202b, to be monitored, i.e., to obtain sensor data from, comprise the points of which the straps restraining the load are fixated to the rails (i.e., the load fixation components).

The one or more restraining components 202a and 202b are monitored by one or more sensors 201′ arranged on the rails 202b, wherein the sensors 201′, e.g., piezoelectric sensors, are operably connected to the one or more restraining components and configured to measure vibrations in the one or more restraining components, e.g., in the rails.

In the system 200c, the one or more sensors 201′ may comprise vibration sensors configured to obtain sensor data, e.g., by measuring vibrations, caused by movement in the one or more restraining components 202a and 202b during transport.

Alternatively or additionally, the one or more sensors 201′ may be operably connected to the rails and configured to measure vibrations and/or shock in the rails caused by movement in the one or more restraining components 202a and 202b during transport.

For example, the one or more sensors 201′ may be embedded in the rails.

In some embodiments, the one or more sensors 201′ comprise piezoelectric sensors.

FIG. 3 is a schematic drawing illustrating components of an example system 300 according to some embodiments. The system 300 is for detecting load shift of cargo on a vehicle and/or a trailer during transport, wherein cargo is restrained to the vehicle and/or the trailer by one or more restraining components. Thus, the system 300 may, for example, comprise the apparatus 400 and/or the controller 410 of FIG. 4; all of which will be described later herein, as well as be configured to perform the method steps of FIG. 1A and/or FIG. 1B.

The system 300 comprises the following components.

Cargo 203 is loaded and restricted on the roof of a vehicle 200.

The cargo 203 is restricted on the vehicle 200 by one or more restraining components 202a and 202b.

The restraining components comprise fastening components 202a connected and/or fixated to one or more load fixation components 202b.

In the system 300, straps, i.e., fastening components 202a, are connected and fixated to rails, i.e., load fixation components 202b, on the roof of the vehicle 200 for restraining the cargo 203 (e.g., a box). The one or more restraining components, i.e., the fastening components 202a and/or load fixation components 202b, to be monitored, i.e., to obtain sensor data from, comprise the points of which the straps restraining the load are fixated to the rails (i.e., load fixation components) and/or one or more sections of the actual straps (i.e., fastening components).

The one or more restraining components 202a and 202b are monitored by one or more sensors 201 arranged on the vehicle (i.e., on the roof of the vehicle) to have a non-obstructed view (i.e., a clear view) of the one or more restraining components 202a and 202b.

Alternatively or additionally, the one or more sensors 201 may be arranged on the one or more restraining components 202a and 202b to have a non-obstructed view of other restraining components 202a and 202b.

Alternatively or additionally, the one or more sensors 201 may be arranged on the cargo 203 to have a non-obstructed view of the restraining components 202a and 202b.

In the system 300, the one or more sensors 201 comprise image sensors and/or camera sensors configured to obtain sensor data, e.g., image data and/or video data, of the one or more restraining components 202a and 202b during transport.

The fastening component 202a, i.e., the strap on the right side holding the box, is illustrated to be in movement. The movement in the fastening component 202a is determined (reference to step 104 of FIG. 1A and/or FIG. 1B) to be of such magnitude that the cargo 203 runs a considerable risk of being load shifted.

In some embodiments, the risk of the cargo being load shifted is communicated to a user of the vehicle 200 through a notification via a display and/or a sound in the vehicle 200.

FIG. 4 is a schematic block diagram illustrating an example apparatus 400 according to some embodiments. The apparatus 400 is for detecting load shift of cargo on a vehicle and/or a trailer during transport, wherein cargo is restrained to the vehicle and/or the trailer by one or more restraining components. Thus, the apparatus 400 and/or the controller 410 may, for example, be configured to perform one or more of the method steps of FIG. 1A and/or FIG. 1B and/or one or more of any steps otherwise described herein.

The apparatus 400 comprises a controller 410, e.g. device controlling circuitry, configured to cause obtainment of sensor data of the one or more restraining components via one or more sensors, wherein the one or more sensors are arranged on the vehicle and/or the trailer.

The controller 410 is further configured to cause reception of the obtained sensor data, comparison of the received sensor data over time in order to establish differences in the received sensor data, determination of whether any established differences in the received sensor data meet or exceed a set threshold for the one or more restraining components, wherein the set threshold is indicative of movement in the one or more restraining components capable of allowing load shift of the cargo.

The apparatus 400 comprises, as mentioned above, the controller (CNTR; e.g., control circuitry or a controlling module) 410, which may in turn comprise, (or be otherwise associated with; e.g., connected or connectable to), an obtainer 401, e.g. obtaining circuitry or obtaining module, configured to obtain sensor data of the one or more restraining components via one or more sensors, wherein the one or more sensors are arranged on the vehicle and/or the trailer (compare with step 101 of FIG. 1A and/or FIG. 1B).

The controller 410 further comprises, (or is otherwise associated with; e.g., connected or connectable to), a receiver 402, e.g. receiving circuitry or receiving module, configured to receive the obtained sensor data (compare with step 102 of FIG. 1A and/or FIG. 1B).

The controller 410 further comprises, (or is otherwise associated with; e.g., connected or connectable to), a comparer 403, e.g. comparing circuitry or comparing module, configured to compare the received sensor data over time in order to establish differences in the received sensor data (compare with step 103 of FIG. 1A and/or FIG. 1B).

The controller 410 further comprises, (or is otherwise associated with; e.g., connected or connectable to), a determiner 404, e.g. determining circuitry or determining module, configured to determine whether any established differences in the received sensor data meet or exceed a set threshold for the one or more restraining components, wherein the set threshold is indicative of movement in the one or more restraining components capable of allowing load shift of the cargo (compare with step 104 of FIG. 1A and/or FIG. 1B).

In some embodiments, the controller 410 further comprises, (or is otherwise associated with; e.g., connected or connectable to), a notifier 405, e.g. notifying circuitry or notifying module, configured to notify a user of the vehicle via a display and/or a sound in the vehicle of movement in the one or more restraining components capable of allowing load shift of the cargo (compare with step 105 of FIG. 1B).

In some embodiments, the controller 410 further comprises a buffer for temporarily storing the received data before comparison.

In some embodiments, the controller 410 and/or the buffer is comprised completely or partially in the vehicle and/or remotely in a cloud environment.

In some embodiments, the apparatus 400 is operably connectable to memory comprised in a vehicle and/or in a cloud environment.

In some embodiments, the vehicle comprises the apparatus 400.

In some embodiments, the apparatus 400 is continuously active during transport for detecting load shift of cargo on the vehicle and/or the trailer or only active when the user of the vehicle activates it during transport.

The apparatus 400 may further optionally comprise, (or be otherwise associated with; e.g., connected or connectable to), in some embodiments, a transceiver TX/RX 420, e.g. transceiving circuitry or transceiving module, configured to transmit and receive radio signals e.g. in accordance with detecting load shift of cargo on a vehicle and/or a trailer during transport.

Generally, when an apparatus is referred to herein, it is to be understood as a physical product. The physical product may comprise one or more parts, such as controlling circuitry in the form of one or more controllers, one or more processors, or the like.

The described embodiments and their equivalents may be realized in software or hardware or a combination thereof. The embodiments may be performed by general purpose circuitry. Examples of general purpose circuitry include digital signal processors (DSP), central processing units (CPU), Graphics Processing Units (GPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a wireless communication device.

Embodiments may appear within an electronic apparatus (such as a wireless communication device) comprising arrangements, circuitry, and/or logic according to any of the embodiments described herein. Alternatively or additionally, an electronic apparatus (such as a wireless communication device) may be configured to perform methods according to any of the embodiments described herein.

According to some embodiments, a computer program product comprises a computer readable medium such as, for example a universal serial bus (USB) memory, a plug-in card, an embedded drive or a read only memory (ROM).

FIG. 5 illustrates an example computer readable medium in the form of a compact disc (CD) ROM 500. The computer readable medium has stored thereon a computer program comprising program instructions. The computer program is loadable into a data processor (PROC) 520, which may, for example, be comprised in a wireless communication device 510. When loaded into the data processor, the computer program may be stored in a memory (MEM) 530 associated with or comprised in the data processor.

In some embodiments, the computer program may, when loaded into and run by the data processing unit, cause execution of method steps according to, for example, FIG. 1A and/or FIG. 1B and/or one or more of any steps otherwise described herein.

In some embodiments, the computer program may, when loaded into and run by the data processing unit, cause execution of steps according to, for example, FIG. 1A and/or FIG. 1B and/or one or more of any steps otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

What is claimed is:

1. A method for detecting load shift of cargo on a vehicle and/or a trailer during transport, wherein cargo is restrained to the vehicle and/or the trailer by one or more restraining components, the method comprising:
obtaining sensor data of the one or more restraining components via one or more sensors, wherein the one or more sensors are arranged on the vehicle and/or the trailer and the sensor data comprises image data and/or video data,
receiving the obtained sensor data in a controlling circuitry,
comparing the received sensor data over time in the controlling circuitry in order to establish differences in the received sensor data, wherein the comparing of the received sensor data comprises a frame-by-frame analysis of the obtained image data and/or video data for establishing differences per frame,
determining in the controlling circuitry whether any established differences in the received sensor data meet or exceed a set threshold for the one or more restraining components, wherein the set threshold is indicative of movement in the one or more restraining components capable of allowing load shift of the cargo, by determining a time between a first and a second frame and a position of the monitored restraining component at the first respectively at the second frame in order to establish if there are any differences in position of the restraining component.

2. The method according to claim 1, wherein the one or more sensors are arranged on the vehicle and/or the trailer to have a non-obstructed view of the one or more restraining components.

3. The method according to claim 1, wherein the one or more sensors are arranged on the vehicle and/or the trailer to be operably connected to the one or more restraining components and configured to measure vibrations in the one or more restraining components.

4. The method according to claim 1, wherein the one or more restraining components comprise one or more fastening components connected and/or fixated to one or more load fixation components.

5. The method according to claim 4, wherein the one or more load fixation components comprise one or more of: rails, tie-downs, chassis, and towbar.

6. The method according to claim 4, wherein the one or more fastening components comprise one or more of: ropes, nets, chains, ratchet straps, tape, wire cable, rubber cord, and straps.

7. The method according to claim 1, wherein the one or more sensors comprise image sensors and/or camera sensors and/or piezoelectric sensors.

8. The method according to claim 1, wherein the sensor data comprises vibration data.

9. The method according to claim 1, wherein the controlling circuitry further comprises a buffer for temporarily storing the received data before comparison.

10. The method according to claim 1, wherein the controlling circuitry and/or the buffer is comprised completely or partially in the vehicle and/or remotely in a cloud environment.

11. The method according to claim 1, wherein cargo is restrained to the roof of the vehicle and/or on the trailer.

12. The method according to claim 1, the method further comprising:
notifying a user of the vehicle via a display and/or a sound in the vehicle of movement in the one or more restraining components capable of allowing load shift of the cargo.

13. A non-transitory computer readable medium, having stored thereon a computer program comprising program instructions, the computer program being loadable into a data processing unit and configured to cause execution of the method according to claim 1 when the computer program is run by the data processing unit.

14. A system for detecting load shift of cargo on a vehicle and/or a trailer during transport, wherein cargo is restrained to the vehicle and/or the trailer by one or more restraining components, the system comprising controlling circuitry configured to cause:
obtainment of sensor data of the one or more restraining components via one or more sensors, wherein the one or more sensors are arranged on the vehicle and/or the trailer and the sensor data comprises image data and/or video data,
reception of the obtained sensor data,
comparison of the received sensor data over time in order to establish differences in the received sensor data, wherein the comparison of the received sensor data comprises a frame-by-frame analysis of the obtained image data and/or video data for establishing differences per frame,
determination of whether any established differences in the received sensor data meet or exceed a set threshold for the one or more restraining components, wherein the set threshold is indicative of movement in the one or more restraining components capable of allowing load shift of the cargo, by determination of a time between a first and a second frame and a position of the monitored restraining component at the first respectively at the second frame in order to establish if there are any differences in position of the restraining component.

15. The system according to claim 14, wherein the one or more sensors are arranged on the vehicle and/or the trailer to have a non-obstructed view of the one or more restraining components.

16. The system according to claim 14, wherein the one or more sensors are arranged on the vehicle and/or the trailer to be operably connected to the one or more restraining components and configured to measure vibrations in the one or more restraining components.

17. The system according to claim 14, wherein the one or more restraining components comprise one or more fastening components connected and/or fixated to one or more load fixation components.

18. The system according to claim 14, wherein the controlling circuitry further comprises a buffer for temporarily storing the received data before comparison.

19. The system according to claim 14, wherein the controlling circuitry and/or the buffer is comprised completely or partially in the vehicle and/or remotely in a cloud environment.

20. The system according to claim 14, wherein the system is further configured to cause notification to a user of the vehicle via a display and/or a sound in the vehicle of movement in the one or more restraining components capable of allowing load shift of the cargo.

21. The system according to claim 14, wherein the system is continuously active during transport for detecting load shift of cargo on the vehicle and/or the trailer or only active when the user of the vehicle activates it during transport.

22. A vehicle comprising the system according to claim 14.
